(19) United States
(12) Patent Application Publication
(10) Pub. No.: US 2009/0129593 A1
(43) Pub. Date: May 21, 2009

(54) Semiconductor device and method for operating the same

(75) Inventor: Masato Ishii, Kanagawa (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 11/921,221

(22) PCT Filed: May 25, 2006
(86) PCT No.: PCT/JP2006/310942

§ 371 Date: Nov. 29, 2007

(30) Foreign Application Priority Data
May 30, 2005 (JP) 2005-158224

(51) Int. Cl. H04L 9/10; G06F 9/445; G06K 19/07

(52) U.S. Cl. 380/59

(57) ABSTRACT

It is an object of the present invention to provide a wireless chip in which a hardware thereof is not required to be modified in each time that encryption algorithm with higher security is developed. In a wireless chip, a circuit capable of communicating information by wireless communication, a CPU, and a memory are included. In the memory, two or more regions, of each a region to which an encryption program is assigned and a region to which a decryption is assigned, are included. Accordingly, a wireless chip in which an encryption/decryption program can be rewritten without modifying a hardware structure can be provided.

### TECHNICAL FIELD

The present invention relates to a semiconductor device that incorporates a CPU (Central Process Unit), has an encryption/decryption function, and be capable of wireless communication, and an operation method the same.

### BACKGROUND ART

In recent years, various encryption algorithm has been developed to improve security of wireless chips and the like. However, the security is not ensured necessarily, and encryption is decoded with speeding up computers in present condition. Therefore, it is considered that encryption algorithm with higher security has been developed year after year, and development frequency has been advanced.

As electronic equipment that includes a semiconductor device having such an encryption function and communicating data wirelessly, electronic equipment in which an encryption program is recorded in a nonvolatile memory incapable of being rewritten is used (for example, see Patent Document 1; Japanese Patent Application Laid-Open No. 2005-505032).

### DISCLOSURE OF INVENTION

Since an encryption program is recorded in a nonvolatile memory incapable of being rewritten in the conventional technique, it is required to remanufacture a nonvolatile memory incapable of being rewritten of a semiconductor device included in electronic equipment in each time when new encryption algorithm is developed in order to further improve security. The electronic equipment itself may be required to be remanufactured in order to remanufacture the nonvolatile memory incapable of being rewritten; therefore, hands and cost are taken.

It is an object of the present invention to provide a wireless chip in which a hardware structure of the wireless chip is not required to be modified in each time when encryption algorithm with higher security is developed.

In the view of the foregoing problem, the present invention can have a function in which an encryption/decryption program can be rewritten by incorporating a CPU and including a memory capable of being rewritten. As a result, a wireless chip having an encryption/decryption function with higher security can be provided without modifying a hardware structure of the wireless chip.

A specific structure of the present invention will be shown below.

According to one aspect of the present invention, a semiconductor device includes a circuit capable of communicating information that is an encryption program or a decryption program by wireless communication, a CPU, and a memory, where the memory has a plurality of regions to which the encryption program or the decryption program is assigned.

According to another aspect of the present invention, a semiconductor device includes a control resistor, a CPU, and a memory, where the memory has a plurality of regions to which at least either an encryption program or a decryption program is assigned, and the CPU decodes encryption information written in the control resistor by activating a decryption program for decoding encryption recorded in the memory in a case where the encryption information is written in the control resistor.

According to another aspect of the present invention, a method for operating a semiconductor device, which includes a circuit capable of communicating information by wireless communication, a CPU, and a memory having a plurality of regions to which a an encryption program is assigned, includes the steps of writing a first encryption program in a first region, writing a second encryption program in a second region, and writing a third encryption program in a third region.

According to another aspect of the present invention, a method for operating a semiconductor device, which includes a circuit capable of communicating information that is an encryption program or a decryption program by wireless communication, a CPU, and a memory having a plurality of regions to which a decryption program is assigned, includes the steps of writing a first decryption program in a first region, writing a second decryption program in a second region, and writing a decryption program in a third region.

According to another aspect of the present invention, a method for operating a semiconductor device, which includes a circuit capable of communicating information that is an encryption program and a decryption program by wireless communication, a CPU, and a memory having a plurality of regions to which an encryption program is assigned, includes the steps of writing a first encryption program in a first region, writing a second encryption program in a second region, and writing a third encryption program in the first region.

According to another aspect of the present invention, a method for operating a semiconductor device, which includes a circuit capable of communicating information that is an encryption program or a decryption program by wireless communication, a CPU, and a memory having a plurality of regions to which a decryption program is assigned, includes the steps of writing a first decryption program in a first region, writing a second decryption program in a second region, and writing a third decryption program in a first region.

In the present invention, as a memory, a memory having a structure capable of being rewritten can be used.

In the present invention, as a memory, a write-once memory can be used.

In accordance with the present invention, a wireless chip that incorporates a CPU and has an encryption/decryption function with higher security can be provided.

### BRIEF DESCRIPTION OF DRAWINGS

FIG. 1 is a diagram showing a configuration of a wireless chip of the present invention;

FIG. 2 is a diagram showing a configuration of a wireless chip of the present invention;

FIG. 3 is a diagram showing a data formation transmitted and received in the present invention;

FIG. 4 is a view of an address structure of a memory of the present invention;

FIG. 5 is a view showing an address structure of EEPROM of the present invention;

FIG. 6 is a view showing a flow chart of the present invention;

FIG. 7 is a view showing a flow chart of the present invention;

FIG. 8 is a view showing a flow chart of the present invention;

FIG. 9 is a view of a flow chart of the present invention;

FIG. 10 is a view showing a flow chart of the present invention;

FIG. 11 is a view showing a flow chart of the present invention;

FIG. 12 is a diagram showing a memory of the present invention;

FIG. 13 is a cross sectional view showing a memory of the present invention;

FIG. 14 is a diagram showing a memory of the present invention;

FIGS. 15A and 15B are diagrams showing a memory of the present invention;

FIG. 16 is a diagram showing an element of a memory of the present invention;

FIGS. 17A and 17B are cross sectional views of a memory of the present invention;

FIG. 18 is a diagram showing a layout of a circuit of the present invention;

FIG. 19 is a diagram showing a layout of a circuit of the present invention;

FIG. 20 is a diagram showing a layout of a circuit of the present invention;

FIG. 21 is a cross sectional view of a transistor of the present invention; and

FIGS. 22A to 22E are views showing layouts of a transistor of the present invention.

### BEST MODE FOR CARRYING OUT THE INVENTION

Embodiment Modes of the present invention will be explained with reference to the accompanying drawings below. However, the present invention can be implemented in many various modes, and it is to be easily understood that various changes and modifications will be apparent to those skilled in the art, unless such changes and modifications depart from the content and the scope of the invention. Therefore, the present invention is not construed as being limited to the description of the following Embodiment Modes. It is to be noted that the same portion or a portion having the same function is denoted by the same reference numeral in all the drawings for explaining Embodiment Modes, and the repeating explanation thereof is omitted.

### Embodiment Mode 1

In the present embodiment mode, a configuration example of a wireless chip of the present invention and an operation example of a wireless chip in the case of receiving information by an electromagnetic wave from a reader/writer will be explained based on drawings. It is to be noted that a device using a semiconductor element such as a wireless chip of the present invention can be called a semiconductor device.

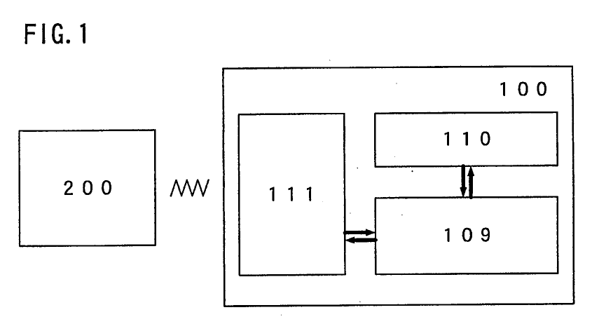

A configuration example of a wireless chip of the present invention is explained with reference to FIG. 1. A wireless chip 100 of the present invention includes a wireless communication circuit 111, a CPU 109, and a memory 110. The wireless communication circuit 111 is a circuit that can communicate information with a reader/writer 200 by an electromagnetic wave. The CPU 109 can implement an instruction in accordance with the instruction included in information from the reader/writer 200.

The memory 110 has a memory incapable of being rewritten, which records an individual identification number of a wireless chip, from a manufacturing step of the wireless chip. In a nonvolatile memory incapable of being rewritten, a program for implementing a general instruction of a CPU is recorded. As a nonvolatile memory incapable of being rewritten, a mask ROM (Read Only Memory) and a write-once memory having an insulator between electrodes of the present invention can be given.

Further, the memory 110 has a memory capable of being rewritten, which records a decryption program for decoding encryption and an encryption program for encrypting information. A program for implementing a general instruction of a CPU may be recorded in the memory capable of being rewritten. As a memory capable of being rewritten, a nonvolatile memory such as a flash memory, an EEPROM (Electrically Erasable Programmable Read Only Memory), or a ferroelectric memory can be given. Furthermore, a volatile memory such as a RAM (Random Access Memory) can be given.

If enough memory capacity used in the present invention can be ensured, a write-once memory of the present invention may be used for a memory that records a decryption program for decoding encryption and an encryption program for encrypting information. Further, the memory 110 has a volatile memory used in a case where a CPU implements an instruction. As a volatile memory, a RAM (Random Access Memory) can be given.

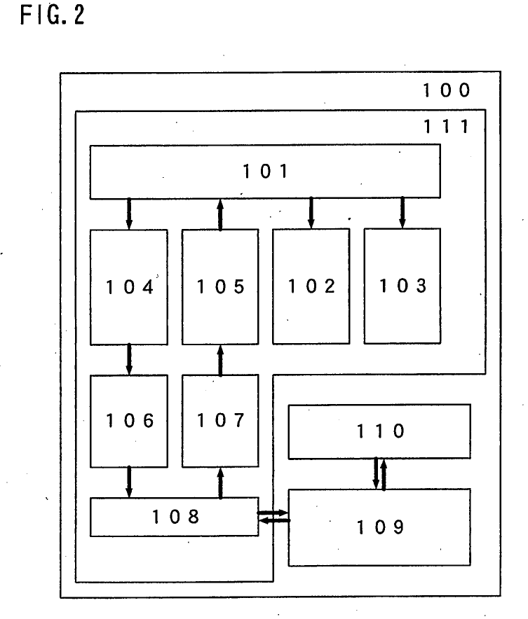

Subsequently, a configuration of a wireless chip of the present invention along with a configuration example of an inside of a wireless communication circuit will be described with reference to FIG. 2. The wireless communication circuit 111 in the wireless chip 100 of the present invention includes a resonance circuit 101 having an antenna and a resonance capacitor, an electric power generation circuit 102, a clock generation circuit 103, a demodulation circuit 104, a modulation circuit 105, a data extraction circuit 106, a coding circuit 107, and a control resistor 108.

The resonance circuit 101 is a circuit that can receive an electromagnetic wave from the reader/writer 200 and generate an alternating current signal on both ends of an antenna. The generated alternating current signal becomes electric power for driving the wireless chip 100 and includes information from the reader/writer 200.

The electric power generation circuit 102 is a circuit that can rectify the alternating current signal generated in the resonance circuit 101 by a diode; smooth the alternating current signal by using a capacitor to generate electric power; and supply the electric power to each circuit such as the resonance circuit, the clock generation circuit, the demodulation circuit, the modulation circuit, the data extraction circuit, the coding circuit, the control resistor, the CPU, and the memory.

The clock generation circuit 103 is a circuit that can generate a clock signal based on the alternating current signal generated in the resonance circuit 101 and supply the clock signal to each circuit.

The demodulation circuit 104 is a circuit that can demodulate the alternating current circuit signal generated in the resonance circuit 101 and transmit demodulated data to the data extraction circuit 106.

The control resistor 108 serves as an interface of the wireless communication circuit and the CPU. Specifically, the control resistor 108 has a function for operating the CPU by information that is written from the data extraction circuit 106, and giving an instruction to the data extraction circuit 106 and the coding circuit 107 by an instruction from the CPU.

The data extraction circuit 106 is a circuit that can extract encryption information from the demodulated data that is transmitted and write the extracted information into the control resistor 108.

When information is written into the control resistor 108, the CPU 109 can implement an instruction in accordance with the instruction included in the information.

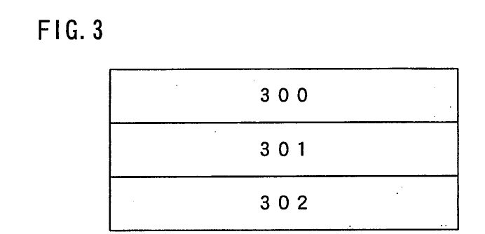

FIG. 3 shows a content example of plaintext information transmitted from the reader/writer used in the present invention. The plaintext information includes an instruction 300 that is implemented by the CPU 109, an address 301 indicating an address of the memory 110, and writing data 302 that is written into the memory indicated by the address 301. The CPU 109 implements operation in accordance with the instruction. Here, the address and the writing data included in the plaintext information are not necessarily required, and they may be not used depending on the instruction.

In a case where information is transmitted from a wireless chip by an instruction from the reader/writer, the CPU 109 writes the information transmitted into the control resistor 108. When the information transmitted into the control resistor 108 is written, the coding circuit 107 reads the information from the control resistor 108, and generates and outputs a coded signal to the modulation circuit 105. The modulation circuit 105 modulates the coded signal and outputs the modulated data to the resonance circuit 101. The resonance circuit 101 transmits the modulated data into the reader/writer by an electromagnetic wave through an antenna.

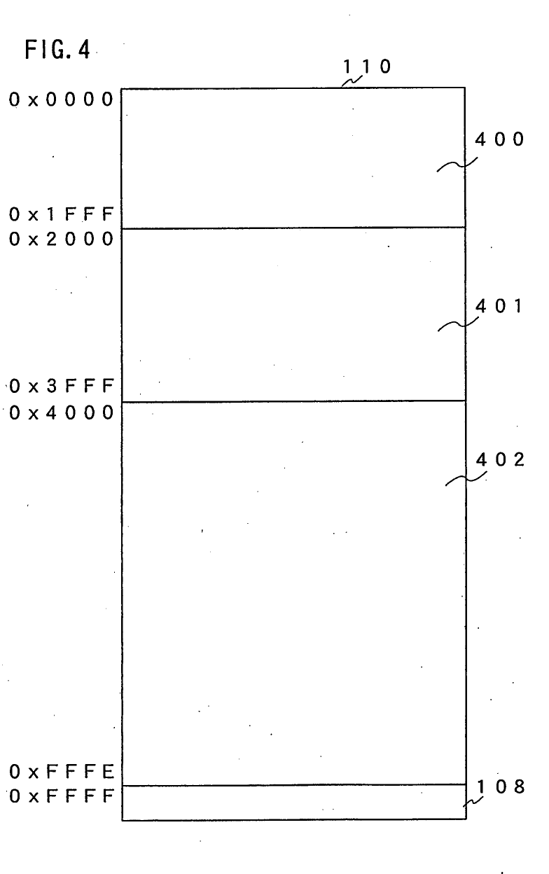

Subsequently, a configuration example of the memory 110 used in the present invention will be explained with reference to FIG. 4. In the present embodiment mode, a case of using an EEPROM as a nonvolatile memory capable of being written is shown.

In FIG. 4, alphanumeric characters such as 0x0000, and 0x2000 indicate an address of a memory, and 0x of first 2 characters of each address indicates hexadecimal notation. For example, 0x2000 is represented as 001000000000000 by binary notation. It is similar for following denotation of addresses.

In a ROM region 400, addresses 0x0000 to 0X1FFF are assigned. In a RAM region 401, addresses 0x2000 to 0x3FFF are assigned. In an EEPROM region 402, addresses 0x4000 to 0xFFFE are assigned. In the control resistor 108, an address 0xFFFF that is a memory mentioned in the present invention or another memory is assigned so that the CPU 109 can access the control resistor 108 as a part of a memory.

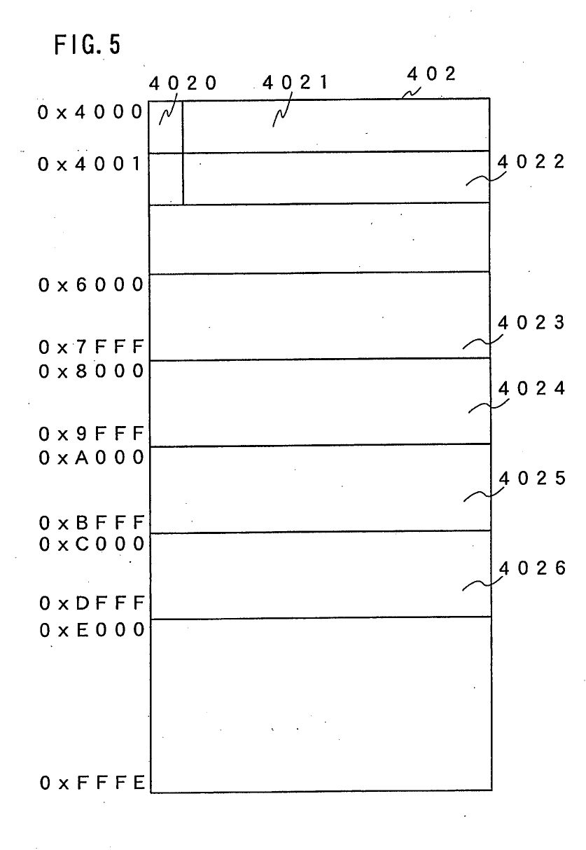

Next, a configuration example of the EEPROM region 402 used in the present invention will be explained with reference to FIG. 5. In one bit of a memory in an address 0x4000, a flag 4020 is assigned. In the other bit in the address 0x4000, an encryption program top address 4021 is assigned. In an address 0x4001, a decryption program top address 4022 is assigned. In addresses 0x6000 to 0x7FFF, a encryption program 1 region 4023 is assigned. In addresses 0x8000 to 0x9FFF, a decryption program 2 region 4024 is assigned. In addresses 0xA000 to 0xBFFF, a decryption program 1 region 4025 is assigned. In addresses 0xC000 to 0xDFFF, a decryption 2 region 4026 is assigned.

Here, two regions of each encryption program region and decryption program region are provided; however, three or more regions each may be provided for as the encryption region and the decryption region, and addresses may be assigned to each region.

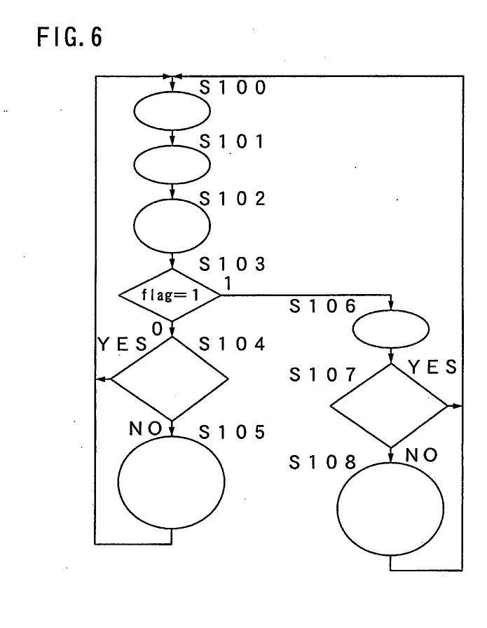

Subsequently, an example of a sequence of operation for writing an encryption/decryption program first into a wireless chip of the present invention will be explained with reference to FIG. 6. It is to be noted that all content of the EEPROM is erased at the time of producing the wireless chip. Alternatively, all content of the EEPROM may be erased at the time of shipping the wireless chip.

A “standby” state of S100 indicates a state in which a wireless chip is waiting for an electromagnetic wave from a reader/writer.

A “receiving instruction” state of S101 indicates a state in which the wireless chip receives an electromagnetic wave; a resonance circuit generates an alternating current signal based on the received electromagnetic wave; an electric power generation circuit generates an electric power that is consumed in each circuit based on the generated alternating current signal and supplies the generated electric power to each circuit; a clock generation circuit generates a clock for operating each circuit synchronously based on the generated alternating current signal and supplies the generated clock to each circuit; a demodulation circuit demodulates an alternating current signal including encryption information and produces demodulated data; and a data extraction circuit extracts the encryption information from the modulated data and writes the encryption information into a control resistor.

A “writing into RAM” state of S102 indicates a state in which a CPU of the wireless chip writes encryption information including an instruction, which is written into a control resistor, into a RAM.

A “flag=1” state of S103 indicates a state in which the CPU reads the address 0x4000 of the EEPROM and confirms a flag value that is assigned to one bit of the read data. When the flag value is “0”, the received instruction is not encrypted. When the flag value is “1”, the received instruction is encrypted. Here, since the instruction is received first by the wireless chip, the flag value is “0”.

A “writing decryption program” state of S104 indicates a state in which the CPU reads the instruction that is written in the RAM to confirm whether the instruction is writing of the decryption program or not. If the instruction is writing of the decryption program, the CPU writes the writing data received with the instruction into an address indicating an inside of the decryption program 1 region received with the instruction. Then, the operation returns to the state S100. The states S100 to S104 are repeated up to writing all the decryption programs into the wireless chip. If the instruction is not writing of the decryption program but an instruction of completion of writing of the decryption program, the operation is advance to a state S105.

A “completion of writing decryption program” state of S105 indicates a state in which the CPU reads the instruction that is written into the RAM to confirm completion of writing the decryption program. When the CPU confirms the instruction of completion of writing the decryption program, “1” is written into the flag, and the writing data received with the instruction is written into the decryption program top address as an address indicating first of the decryption program 1 region. Then, the operation returns to the state S100. Here, since a flag value becomes “1”, an instruction that is received from next time is encrypted.

As described above, the decryption program can be recorded in the memory of the wireless chip.

Next, when the wireless chip receives an instruction of writing a encryption program that is encrypted as an electromagnetic wave from the reader/writer, states change from S100 to S103. In S103, a flag value is “1”; therefore, the operation is advanced to a state S106.

A “decryption” state of S106 indicates a state in which the CPU reads the decryption program top address from the address 0x4001, reads sequentially the decryption program from the decryption program 1 region indicated by the read decryption program top address, and decrypts an encrypted instruction that is written in the RAM. Then, the CPU writes the decrypted instruction into the RAM region.

A “writing encryption program” state of S107 indicates a state in which the CPU reads the decrypted instruction that is written into the RAM to confirm whether the instruction is writing of the encrypted program or not. If the instruction is writing of the encryption program, the CPU writes the writing data that is received with the instruction into an address indicating the inside of the encryption program 1 region that is received with the instruction. Thereafter, the operation returns to the state S100. The states S100 to S107 are repeated up to writing all encrypted programs into the wireless chip. If the instruction is not writing of the encryption program but completion of writing the encryption program, the operation is advanced to a state S108.

A “completion of writing encryption program” state of S108 indicates a state in which the CPU reads the decrypted instruction that is Written in the RAM to confirm the instruction that is completion of writing the encryption program. When the CPU confirms the instruction of completion of writing the encryption program, the writing data that is received with the instruction is written into the encryption program top address as an address indicating first of the encryption program 1 region. The operation returns to the state S100.

As described above, the encryption program is recorded in the memory of the wireless chip, and the wireless chip is to be able to perform operation of encryption and decryption.

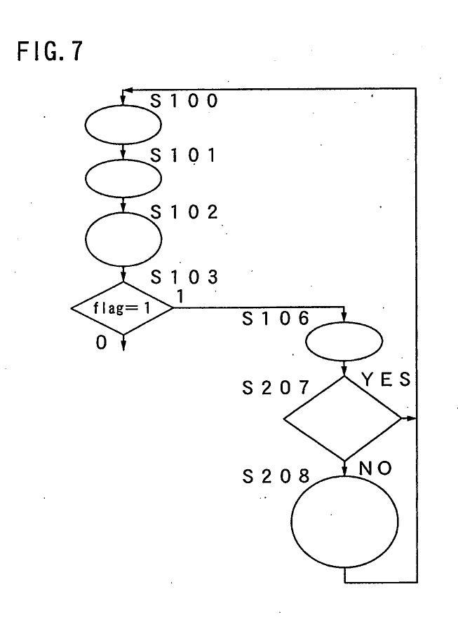

Subsequently, an example of a sequence of operation for rewriting an encryption/decryption program of a wireless chip of the present invention will be explained with reference to FIG. 7. Here, an encryption/decryption program is written into the wireless chip, and encryption information is communicated between the wireless chip and a reader/writer. When the wireless chip receives an instruction of rewriting decryption program that is encrypted as an electromagnetic wave from the reader/writer, a flag value is “1”; therefore, states change from S100 to S106 as similar to the above.

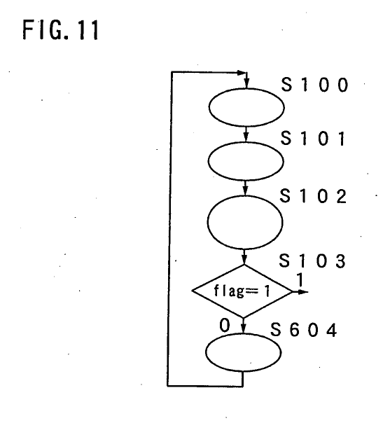

When the flag vale is “0”, the operation is advanced to the “writing decryption program” state of S104 as shown in FIG. 6. Alternatively, the operation is advance to an “instruction treatment” state of S604 as shown in FIG. 11 that is described below.

A “rewriting decryption program” state of S207 indicates a state in which the CPU reads the decrypted instruction that is written into the RAM to confirm whether the instruction is rewriting of the decryption program or not. If the instruction is rewriting the decryption program, the CPU writes the writing data that is received with the instruction into an address indicating the inside of the encryption program 2 region that is received with the instruction. Then, the operation returns to the state S100. The states of S100 to S207 are repeated up to writing all rewriting decrypted programs into the wireless chip. If the instruction is not rewriting the decryption program but completion of rewriting the decryption program, the operation is advance to a state S208.

A “completion of rewriting decryption program” state of S208 indicates a state in which the CPU reads the decrypted instruction that is written into the RAM to confirm the instruction that is completion of rewriting the decryption program. When it is confirmed that the instruction is completion of rewriting the decryption program, the CPU rewrites the writing date that is received with the instruction into the decryption program top address as an address indicating first of the decryption program 2 region. Then, the operation returns to the state S100. Since the decryption program top address is rewritten, the CPU does not access the decryption program that is recorded in the decryption program 1 region.

In operation of rewriting the encryption program, an instruction that is received by the wireless chip as an electromagnetic wave from the reader/writer is changed into an instruction of rewriting the encryption program and an instruction of completion of rewriting an encryption program. The other operation is the same as the mentioned above; therefore, explanation is omitted.

As described above, a new encryption/decryption program is recorded in the memory of the wireless chip, and then the wireless chip is to be able to perform new operation of encryption and decryption. In addition, in the case of writing a new encryption/decryption program into the wireless chip, the above rewriting operation is performed after erasing the information of the encryption program 1 region and the decryption program 1 region. In such a manner, the wireless chip of the present invention can record a new encryption/decryption program constantly to perform operation of encryption and decryption by alternately using the encryption program 1 region and the decryption program 1 region; and the encryption program 2 region and the decryption program 2 region.

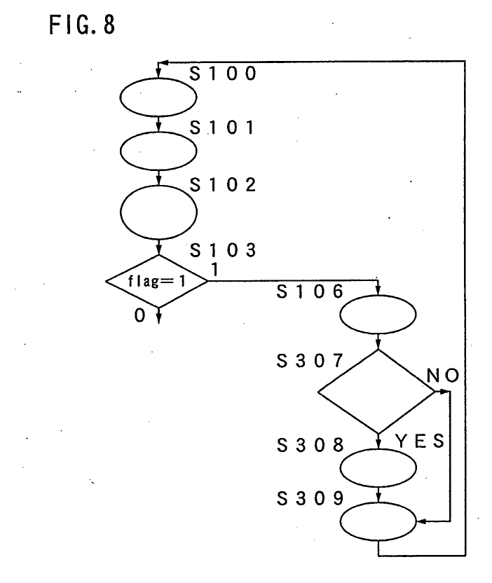

Subsequently, an example of a sequence operation in which the wireless chip of the present invention transmits information in the memory of the wireless chip to the reader/writer, will be explained with reference to FIG. 8. Here, the encryption/decryption program is written into the wireless chip, and the encryption information is communicated between the wireless chip and the reader/writer.

When the wireless chip receives an encrypted instruction of transmitting information with encryption, a flag value is “1”; therefore, the states change from S100 to S106 as similar to the above.

When, the flag value is “0”, the operation is advance to the “writing decryption program” state of S104 as shown in FIG. 6. Alternatively, the operation is advanced to the “instruction treatment” state of S604 as shown in FIG. 11 described below.

A “transmitting information with encryption” state of S307 indicates a state in which the CPU reads the decrypted instruction that is written into the RAM to confirm whether the instruction is transmitting information with encryption or not. If the instruction is transmitting information with encryption, the CPU reads the information indicated by an address that is received with the instruction to write the information into the RAM. If the instruction is not transmitting information with encryption but transmitting information without encryption, the operation is advanced to a state S309.

An “encryption” state of S308 indicates a state in which the CPU reads an encryption program top address from the address 0x4000, and reads sequentially an encryption program from the encryption program 1 or 2 region indicated by the read encryption program top address to encrypt the information that is written into the RAM. The CPU writes the encrypted information into the control resistor. If the instruction is not the transmitting information with encryption but the transmitting information without the encryption, the CPU writes the information that is read from the memory into the control resistor without encrypting the information.

A “transmitting” state of S309 indicates a state in which after the CPU writes the encryption information or the unencryption information into the control resistor, a coding circuit generates a coded signal based on the written information and outputs the coded signal into a modulation circuit; and the modulation circuit modulates the coded signal, and transmits modulated data through the resonance circuit. Thereafter, the operation returns to the state S100. As described above, the wireless chip can transmit the information, which is encrypted or unencrypted, in the memory of the wireless chip to the reader/writer.

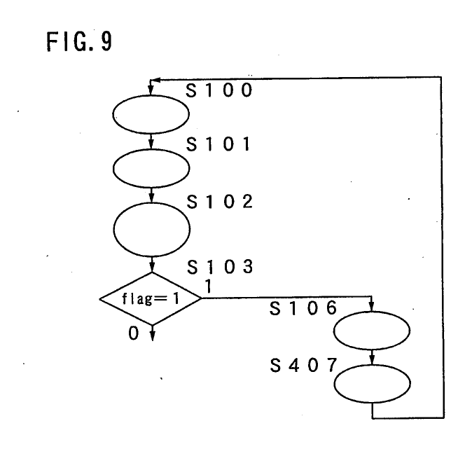

Subsequently, an example of a sequence of operation up to which the wireless chip of the present invention implements an encrypted instruction that is received from the reader/writer, will be explained with reference to FIG. 9.

Here, an encrypted/decrypted program is written into the wireless chip, and the encrypted information is communicated between the wireless chip and the reader/writer. When the wireless chip receives the encrypted information by an electromagnetic wave from the reader/writer, states changes from S100 to S106 as similar to the above because a flag value is “1”.

When the flag value is “0”, the operation is advanced to the “writing decryption program” state of S104 as shown in FIG. 6. Alternatively, the operation is advanced to the “instruction treatment” of S604 as mentioned in FIG. 11 below.

A “instruction treatment” state of S407 indicates a state in which the CPU reads the decrypted instruction that is written into the RAM and operates in accordance with the instruction. The instruction mentioned here indicates a general instruction of a CPU such as four operations, reading from a memory, writing into a memory, branching, and interrupt treatment. The operation returns to the state S100.

As described above, the wireless chip can implement the encrypted instruction that is received from the reader/writer.

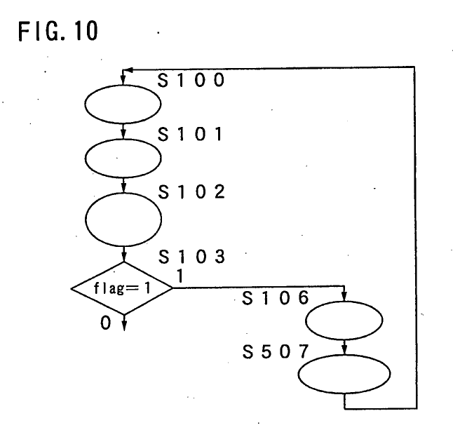

Subsequently, an example of a sequence of operation up to which the wireless chip of the present invention can receive unencrypted information from the reader/writer will be explained with reference to FIG. 10. Here, an encryption/decryption program is written into the wireless chip, and the encryption information is communicated between the wireless chip and the reader/writer.

When the wireless chip receives a cryptography communication suspended instruction that is encrypted by an electromagnetic wave from the reader/writer, states changes from S100 to S106 as similar to the above because the flag value is “1”.

When the flag value is “0”, the operation is advanced to “writing decryption program” state of S104 as shown in FIG. 6. Alternatively, the operation is advanced to the “instruction treatment” state of S604 as shown in FIG. 11 mentioned below.

A “flag→0” state of S507 indicates a state in which the CPU reads the decrypted instruction written into the RAM to confirm the instruction that is cryptography suspension. When, the instruction is confirmed to be cryptography suspension, the CPU writes “0” into the flag. Here, since the value of the flag becomes “0”, the instruction is not encrypted from a next received instruction. Then, the operation returns to the states S100.

As described above, the wireless chip can communicates the unencrypted information with the reader/writer.

Subsequently, an example of a sequence of operation up to which the wireless chip of the present invention implements an unencrypted instruction that is received from the reader/writer, will be explained with reference to FIG. 11. Here, the wireless chip communicates the unencrypted information with the reader/writer.

When the wireless chip receives an unencrypted instruction by an electromagnetic wave from the reader/writer, states changes from S100 to S103 as similar to the above, and the operation is advanced to the state S604 because the flag value is “0”.

When the flag value is “1”, the “modulation” the operation is advanced to the state of S106 as shown in FIG. 6 to FIG. 10.

The “instruction treatment” state of S604 indicates a state in which the CPU reads the unencrypted instruction that is written into the RAM, and operates in accordance with the instruction. The instruction mentioned here indicates a general instruction of a CPU such as four operations, reading from a memory, written into a memory, branching, and interrupt treatment. Thereafter, the operation returns to the state S100.

As described above, the wireless chip can implement the unencrypted instruction that is received from the reader/writer. It is to be noted that the instruction here may be a decryption program writing instruction or an encryption program writing instruction. The decryption program writing instruction or the encryption program writing instruction, which is not encrypted, is received, and the decryption program or the encryption program is to be able to be written into the wireless chip.

In a case where encryption algorithm with higher security is developed so that the wireless chip of the present invention has a function in which the above encryption/decryption program can be rewritten, an encryption program using encryption algorithm with high security, which is newly developed, can be mounted at any time. As a result, a wireless chip that has an encryption/decryption function with higher security can be provided without modifying a hardware structure of the wireless chip.

Further, since the encryption program that is newly mounted is encrypted for transmitting to the wireless chip in the present invention, the encryption algorithm that is mounted on the wireless chip is hardly specified; therefore, the wireless chip that has a decoding function with higher security can be provided. In a case where a decryption program is written into the wireless chip first, the decryption program that is written is not encrypted; however, the security is ensured by performing writing the decryption program in product lines of makers or the like before shipment to users.

In accordance with such a present invention, a wireless chip that incorporates a CPU and has an encryption/decryption function with higher security can be provided.

### Embodiment Mode 2

In the present embodiment mode, an EEPROM that can be applied to a wireless chip and an operation method thereof will be explained.

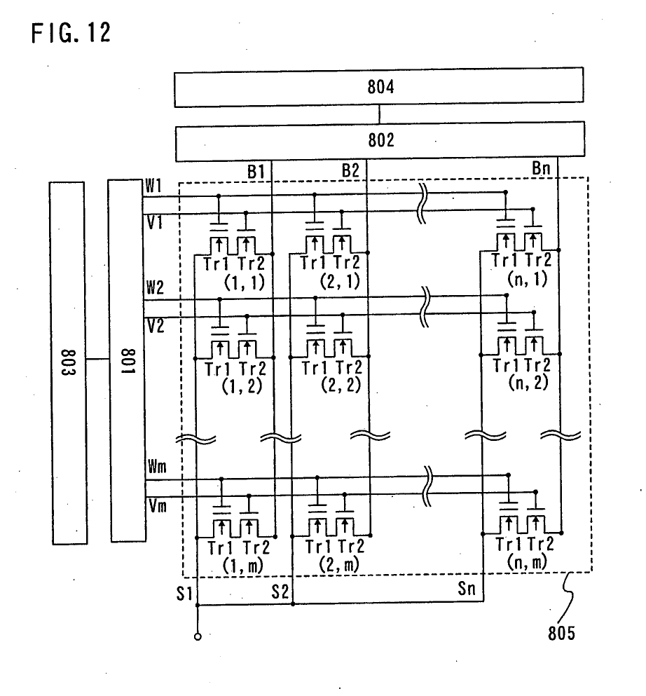

FIG. 12 shows a circuit diagram of an EEPROM. The EEPROM in FIG. 12 includes a memory cell array 805 in which a plurality of memory cells (1,1) to (m, m) are arranged in a matrix shape of m pieces longitudinally x n pieces horizontally, a X address decoder 801, a Y address decoder 802, and other peripheral circuits 803 and 804. The other peripheral circuits include an address buffer circuit, a control logic circuit, a sense amplifier, a boosting circuit, and the like, and they are provided as needed.

Each memory cell (a memory cell (i, j) is considered as a representative example) (i is an integer number that is 1 or more and n or less, and j is an integer number that is 1 or more and m or less) has an n-channel memory transistor Tr1 and an n-channel select transistor Tr2. These two transistors are connected in series. A source electrode and a control gate electrode of the memory transistor Tr1 are respectively connected to a source line Si and a word line Wj. A drain electrode and a gate electrode of the select transistor Tr2 are respectively connected to a bit line Bi and a select line Vj. Further, bit lines B1 to Bn are connected to the Y address decoder 802, and word lines W1 to Wm and select lines V1 to Vm are connected to the X address decoder 801, respectively. Predetermined potential Vs is given to all source lines S1 to Sn in common. In a case where the memory transistor included in each memory cell stores data of 1 bit, the EEPROM shown in FIG. 12 has memory capacity of m x n bit.

Writing, reading, and erasing of data are performed in one memory cell that is selected by the X address decoder 801 and the Y address decoder 802. Operation of writing, reading, and erasing will be explained by taking a memory cell (1, 1) as an example. It is to be noted that the writing operation indicates operation of injecting electrons into a floating gate electrode of the memory transistor, and the erasing operation indicates operation of discharging electrons from the floating gate electrode in the present specification. Accordingly, a threshold voltage of the memory transistor is increased by the writing operation, and the threshold voltage is reduced by the erasing operation.

First, in a case where data is written into the memory transistor Tr1, the source lines S1 to Sn are connected to ground, and a positive high voltage (for example, 20 V) is applied to each of the bit line B1 and the word line W1. Further, such a positive voltage (for example, 20 V) is applied to the select line V1 that the select transistor Tr2 is turned on. Under such a condition, a high electric field is generated in neighborhood of a drain in the memory transistor Tr1, and impact ionization occurs. Furthermore, since the high electric field is also generated in the direction of the gate, generated hot electrons are injected into the floating gate electrode; therefore, writing is performed. The threshold voltage of the memory transistor Tr1 is changed depending on the amount of electric charge that is accumulated in the floating gate electrode.

In a case where data that is stored in the memory transistor Tr1 is read, the source lines S1 to Sn are connected to ground, and a predetermined voltage (described later) is applied to the word line W1. Further, such a voltage (for example, 5v) is applied to the select line. V1 that the select transistor is turned on. Then, data stored in the memory cell is read from the bit line B1 depending on a threshold voltage in a case where the electric charge is accumulated or in a case where the electric charge is not accumulated in the floating gate electrode of the memory transistor Tr1.

It is to be noted that the predetermined voltage may be set between a threshold voltage in an erased state (a state in which electrons are not stored in the floating gate electrode) and a threshold voltage in a written state (a state in which electrons are stored in the floating gate electrode). For example, in a case where a memory transistor in the erased state has a threshold voltage of 2 V or less, and a memory transistor in the written state has a threshold voltage of 4 V or more, specifically, 3V can be used as the predetermined voltage.

In a case where the data recorded in the memory transistor Tr1 is erased, the source line S1 and the word line W1 are connected to ground, and a positive high voltage (for example, 20 V) is applied to the bit line B1. Further, a positive high voltage (for example, 20 V) is applied to the select line V1, and the select transistor Tr2 is turned on. At this time, since a high potential difference is generated between the gate and drain of the memory transistor Tr1, the electrons that is stored in the floating gate electrode is released to the drain region by a tunnel current, and erasing is performed.

It is to be noted that potential of the signal lines B2 to Bn and W2 to Wm that are not selected at the time for writing, reading, and erasing is all 0 V. Further, the above value of an operation voltage is an example, and a value is not limited thereto. When the data is written, read, and erased in the selected memory cell (1, 1), data must not be written, read, and erased in the non-selected memory cells (in this case, all memory cells other than the memory cell (1, 1)) in order to perform operation for every 1 bit. Actually, in memory cells other than that of a first row, the select transistor is turned off because the select lines V2 to Vn are 0 V. Therefore, writing and erasing in the memory transistor is not performed, and there is no influence of reading. Further, in the memory cells other than that of the first row, a potential difference is not generated between the source lines and bit lines. Therefore, writing into the memory cell is not performed, and there is no influence of reading. Since a potential difference is not generated between the word lines and the bit lines, erasing is not performed either.

As described above, writing, reading, and erasing data in the selected memory cell (1, 1) are performed without a malfunction of the non-selected memory cells. Such operation of writing, reading, and erasing are performed in accordance with the CPU 109. The CPU 109 can write an encryption/decryption program into such a memory cell, and can read and erase the written encryption/decryption program.

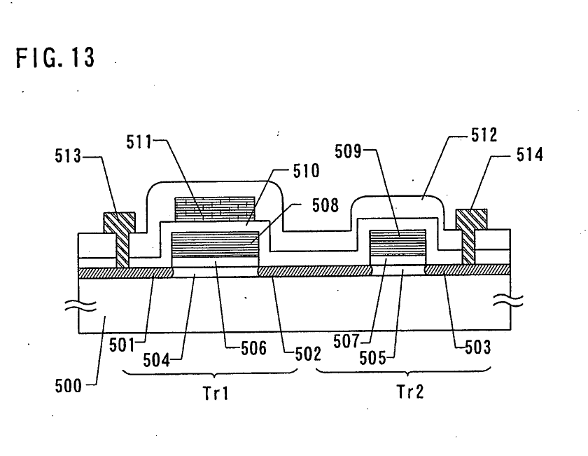

Subsequently, FIG. 13 shows a typical cross sectional structure of a memory cell constituting an EEPROM. In FIG. 13, a memory transistor Tr1 (n-channel type) and a select transistor tr2 (n-channel) are formed over an insulating substrate 500. The memory transistor Tr1 includes source and drain regions (high concentration n-type impurity regions) 501 and 502, and a channel forming region 504, which are formed in the vicinity of a surface of the insulating substrate 500, a first gate insulating film 506, a floating gate electrode 508, a second gate insulating film 510, and a control gate electrode 511. The select transistor Tr2 includes source and drain regions (high concentration n-type impurity regions) 502 and 503, and a channel forming region 505, which are formed in the vicinity of the surface of the insulating substrate 500, a first gate insulating film 507, and a gate electrode 509. Further, a source wiring 513 and a drain wiring 514 are led over an interlayer film 512 through contact holes.

In FIG. 13, the drain region 502 of the memory transistor Tr1 is partially overlapped with the floating gate electrode 508 with the first gate insulating film 506 interposed therebetween. The overlapped region is a region where a tunnel current flows in the erasing operation.

### Embodiment Mode 3

In the present embodiment mode, a memory used for a write-once memory included in a wireless chip and an operation method thereof will be explained.

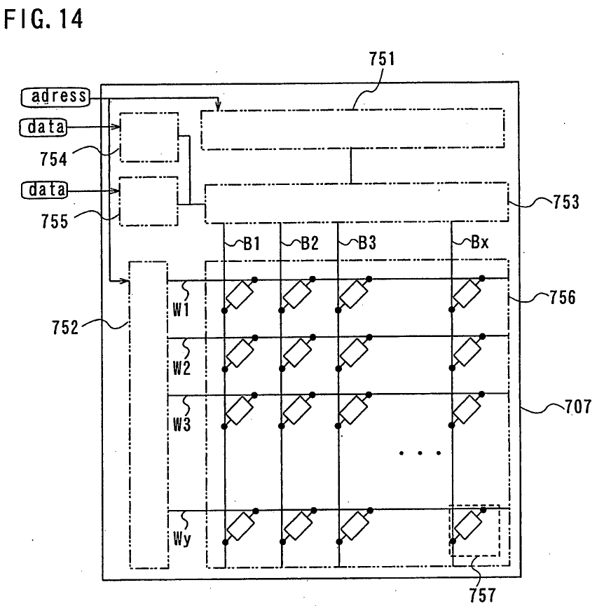

As shown in FIG. 14, a memory 707 includes a memory cell array 756 in which a memory element is formed, and a driver circuit. The driver circuit includes a column decoder 751, a row decoder 752, a reading circuit 754, a writing circuit 755, and a selector 753.

The memory cell array 756 has a bit line Bm (m=1 to x), a word line Wn (n=1 to y), and a memory cell 757 at an intersection of each bit line and word line. It is to be noted that the memory cell 757 may be an active type to which a transistor is connected or a passive type that is constituted by only a passive element. Further, the bit line Bm is controlled by the selector 753, and the word line Wn is controlled by the TOW decoder 752.

The column decoder 751 receives an address signal that specifies an arbitrary bit line and transmits a signal to the selector 753. The selector 753 receives the signal of the column decoder 751 to select the specified bit line. The row decoder 752 receives an address signal that specifies an arbitrary word line and selects the specified word line. By the above operation, one memory cell 757 corresponding to the address signal is selected. The reading circuit 754 reads and outputs information that is included in the selected memory cell. The writing circuit 755 generates a voltage that is necessary for writing and applies the voltage to the selected memory cell to perform writing of information.

The present invention can provides a semiconductor device that incorporates a CPU, has an encryption/decryption function with constantly high security, and includes a memory using a write-once memory.

Subsequently, a circuit configuration of the memory cell 757 will be explained. In the present embodiment mode, a memory cell that includes a lower electrode, upper electrode, and a memory element 783 in which a memory material layer is interposed between a pair of the electrodes, will be explained.

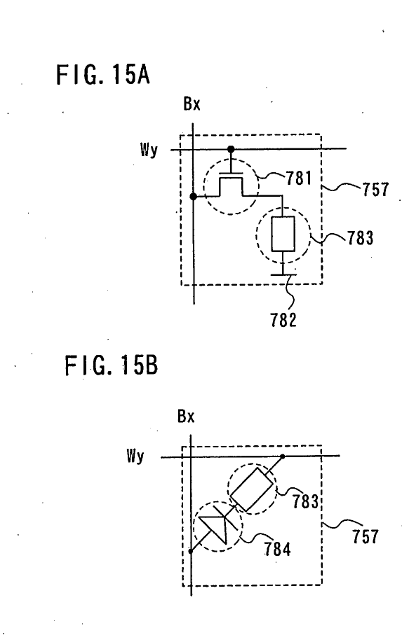

The memory cell 757 shown in FIG. 15A is an active type memory cell including a transistor 781 and the memory element 783. The transistor 781 can employ a thin film transistor (TFT). A gate electrode included in the transistor 781 is connected to a word line Wy. Further, one of a source electrode and a drain electrode included in the transistor 781 is connected to a bit line Bx, and the other electrode is connected to the memory element 783. The lower electrode of the memory element 783 is electrically connected to one of the source electrode and the drain electrode of the transistor 781. Further, the upper electrode (corresponding to 782) of the memory element 783 can be used as a common electrode in each memory element.

Further, as shown in FIG. 15B, a configuration in which the memory element 783 is connected to a diode 784 may also be used. The diode 784 can employ a configuration so-called a diode-connecting configuration in which one of a source electrode and a drain electrode of the transistor is connected to a gate electrode. Alternatively, as the diode 784, a Schottky diode in which a memory material layer and a lower electrode are contacted, or a diode that is formed by stacking memory materials can be utilized.

As the memory material layer, a material in which characteristics and a state are changed due to electric action, optical action, thermal action, or the like, can be used. For example, a material in which a lower electrode and an upper electrode can be short-circuited by change in characteristics and a state thereof due to melting, a dielectric breakdown, and the like by Joule heat, may be used. Therefore, a thickness of the memory material layer may be 5 nm to 100 nm, preferably, 10 nm to 60 nm. Such a memory material layer can be formed using an inorganic material or an organic material by an evaporation method, a spin coating method, a droplet discharging method, or the like.

As the inorganic material, silicon oxide, silicon nitride, silicon oxynitride, or the like is given. Even in such an inorganic material, a dielectric breakdown is generated by controlling a film thickness thereof so that a lower electrode and an upper electrode can be short-circuited.

As the organic material, for example, an aromatic amine compound (in other words, a compound having a benzene ring-nitrogen bond) such as 4,4′-bis[N-(1-naphthyl)-N-phenyl-amino]-biphenyl (abbreviation: α-NPD), 4,4′-bis[N-(3-methylphenyl)-N-phenyl-amino]-biphenyl (abbreviation: TPD), 4,4′,4″-tris(N,N-diphenyl-amino)-triphenylamine (abbreviation: TDATA), 4,4′,4″-tris[N-(3-methylphenyl)-N-phenyl-amino]-triphenylamine (abbreviation: MTDATA), or 4,4′-bis(N-(4-(N,N-di-m-tolylamino)phenyl)-N-phenylamino)biphenyl (abbreviation: DNTPD); polyvinyl carbazole (abbreviation: PVK); or a phthalocyanine compound such as phthalocyanine (abbreviation: H₂Pc), copper phthalocyanine (abbreviation.: CuPc), or vanadyl phthalocyanine (abbreviation: VOPc); or the like can be used. These materials are substances with a high electron transporting property.

In addition, as the organic material, for example, a material formed of a metal complex having a quinoline skeleton or a benzoquinoline skeleton or the like such as tris(8-quinolinolato)aluminum (abbreviation: Alq₃), tris(4-methyl-8-quinolinolato)aluminum (abbreviation: Almq₃), bis(10-hydroxybenzo[h]-quinolinato)beryllium (abbreviation: BeBq₂), or bis(2-methyl-8-quinolinolato)-4-phenylphenolato-aluminum (abbreviation: BAlq), or the like can be used. Alternatively, a material of a metal complex having an oxazole or thiazole ligand such as bis[2-(2-hydroxyphenyl)benzoxazolato]zinc (abbreviation: Zn(BOX)₂) or bis[2-(2-hydroxyphenyl)benzothiazolato]zinc (abbreviation: Zn(BTZ)₂), or the like can be used. These materials are substances with a high electron transporting property.

In addition to the metal complex, a compound such as 2-(4-biphenylyl)-5-(4-tert-butylphenyl)-1,3,4-oxadiazole (abbreviation: PBD); 1,3-bis[5-β-tert-butylphenyl)-1,3,4-oxadiazol-2-yl]benzene (abbreviation: OXD-7); 3-(4-tert-butylphenyl)-4-phenyl-5-(4-biphenylyl)-1,2,4-triazole (abbreviation: TAZ); 3-(4-tert-butylphenyl)-4-(4-ethylphenyl)-5-(4-biphenylyl)-1,2,4-triazole (abbreviation: p-EtTAZ); bathophenanthroline (abbreviation: BPhen); or bathocuproin (abbreviation: BCP); can be used.

Further, the memory material layer may have a single layer structure or a stacked layer structure. In the case of the stacked layer structure, a material can be selected from the above materials to form the stacked layer structure. Alternatively, the above organic materials and a light emitting material may be stacked. As the light emitting material, 4-(dicyanomethylene)2-methyl-6-[2-(1,1,7,7-tetramethyljulolidin-9-yl)ethenyl]-4H-pyran (abbreviation: DCJT); 4-(dicyanomehtylene)-2-tert-butyl-6-[2-(1,1,7,7-tetramethyljulolidin-9-yl)ethenyl]-4H-pyran (abbreviation: DCJTB); periflanthene; 2,5-dicyano-1,4-bis[2-(10-methoxy-1,1,7,7-tetramethyljulolidin-9-yl)ethenyl]benzene; N,N′-dimethylquinacridone (abbreviation: DMQd); coumarin 6; coumarin 545T; tris(8-quinolinolato)aluminum (abbreviation: Alq3); 9,9′-bianthryl; 9,10-diphenylanthracene (abbreviation: DPA); 9,10-bis(2-naphthyl)anthracene (abbreviation: DNA); 2,5,8,11-tetra-t-butylperylene (abbreviation: TBP); or the like can be used.

Furthermore, a layer that is formed by dispersing the above light-emitting material may also be used. As a parent material in the layer that is formed by dispersing the light-emitting material, an anthracene derivative such as 9,10-di(2-naphthyl)-2-tert-butylanthracene (abbreviation: t-BuDNA); a carbazole derivative such as 4,4′-bis(N-carbazolyl)biphenyl (abbreviation: CBP); a metal complex such as bis[2-(2-hydroxyphenyl)pyridinato]zinc (abbreviation: ZnpP₂), Or bis[2-(2-hydroxyphenyl)benzoxazolato]zinc (abbreviation: ZnBOX); or the like can be used. Further, tris(8-quinolinolato)aluminum (abbreviation: Alq₃), 9,10-bis(2-naphthyl)anthracene (abbreviation: DNA), bis(2-methyl-8-quinolinolato)-4-phenylphenolato-aluminum (abbreviation: BAlq), or the like can be used.

Such an organic material changes characteristics thereof due to thermal action or the like. Therefore, a glass-transition temperature (Tg) may be 50° C. to 300° C., preferably, 80° C. to 120° C.

Further, a material in which metal oxide is mixed into an organic material or a light-emitting material may be used. It is to be noted that a material in which metal oxide is mixed includes a state in which the above organic material or light-emitting material, and metal oxide are mixed; or a state in which the above organic material or light emitting material, and metal oxide are stacked. Specifically, the material in which metal oxide is mixed indicates a state that is formed by a co-evaporation method using a plurality of evaporation sources. Such a material can be called an organic-inorganic composite material.

For example, in the case of mixing a substance with a high hole transporting property and metal oxide, as the metal oxide, vanadium oxide, molybdenum oxide, niobium oxide, rhenium oxide, tungsten oxide, ruthenium oxide, titanium oxide, chromium oxide, zirconium oxide, hafnium oxide, or tantalum oxide is preferably used.

In the case of mixing a substance with a high electron transporting property and metal oxide, as the metal oxide, lithium oxide, calcium oxide, sodium oxide, potassium oxide, or magnesium oxide is preferably used.

As the memory material layer, a material in which characteristics are changed due to electric action, optical action, or thermal action may be used. Therefore, for example, a conjugated high-molecular compound doped with a compound that produces acid by light absorption (photoacid generator) can also be used. As the conjugated high-molecular compound, polyacetylene, polyphenylene vinylene, polythiophene, polyaniline, polyphenylene ethynylene, or the like can be used. As the photoacid generator, arylsulfonium salts, aryliodonium salts, o-nitrobenzyl tosylate, aryl sulfonic acid p-nitrobenzyl ester, sulfonyl acetophenone, Fe-allene complex PF₆ salts, or the like can be used.

Subsequently, operation in a case where information is written into the active type memory cell 757 as shown in FIG. 15A will be explained. In the present embodiment mode, a value stored in a memory element in an initial state is “0”, and a value stored in the memory element in which characteristics are changed due to electric action or the like is “1”. Further, the memory element in an initial state has a high resistance value, and the memory element after change has a low resistance value.

In the case of performing writing, a bit line Bm in the m-the column and a word line Wn in the n-th row are selected by the column decoder 751, the row decoder 752, and the selector 753. Then, the transistor 781 included in the memory cell 757 in the m-th column and the n-th row is turned on.

Next, a predetermined voltage is applied to the bit line Bm in the m-column for a predetermined period by the writing circuit 755. For the applied voltage and applying period, a condition for changing the memory element 783 from the initial state to a low resistance value state is used. The voltage that is applied to the bit line Bm in the m-th column is transmitted to the lower electrode of the memory element 783, and a potential difference is generated between the lower electrode and the upper electrode. Then, a current flows in the memory element 783 to generate change in a state of the memory material layer, and characteristics of the memory element is changed. Thereafter, a value stored in the memory element 783 is changed from “0” to “1”.

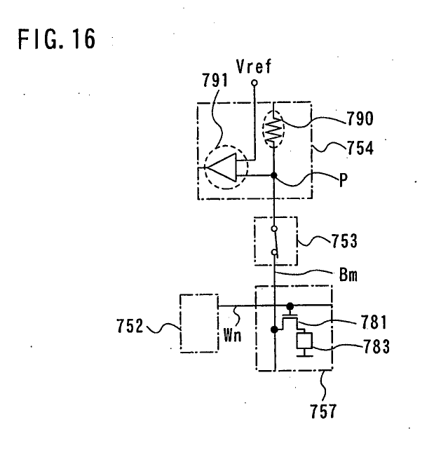

Subsequently, operation of performing reading of information will be explained. As shown in FIG. 16, a reading circuit 754 includes a resistance element 790 and a sense amplifier 791. As for reading of information, a voltage is applied between the lower electrode and the upper electrode to determine whether the memory element is an initial state or a state after change. Specifically, reading of information can be performed by a resistance-dividing method.

For example, a case where reading information of the memory element 783 in the m-th column and the n-th row from a plurality of the memory elements 783 included in the memory cell array 756 is performed is explained. First, a bit line Bm in the m-th column and a word line Wn in the n-th row are selected by the column decoder 751, the row decoder 752, and the selector 753. Then, the transistor 781 included in the memory cell 757 arranged in the m-th column and the n-th row is turned on, and the memory element 783 and the resistance element 790 are connected in series. As a result, potential of P point shown in FIG. 16 is determined depending on current characteristics of the memory element 783.

Potential of the P point in a case where the memory element is in an initial state is set to be V1, and potential of the P point in a case where the memory element is in low resistance state after change is V2. Then, reference potential Vref is used, which fulfills V1>Vref>V2. Accordingly, information that is stored in the memory element can be read. Specifically, in the case where the memory element is in an initial state, output potential of the sense amplifier 791 is Lo. In addition, in the case where the memory element is in a low resistance state, output potential of the sense amplifier 791 is Hi.

In accordance with the above method, information is read by a voltage value by utilizing a difference of the resistance value of the memory element 783 and a resistance-dividing method. However, information included in the memory element 783 may be read by a current value. It is to be noted that the reading circuit 754 of the present invention is not limited to the above configuration, and any configuration may be employed as far as information included in the memory element can be read.

A memory element having such a configuration is changed from a “0” state to a “1” state. The change from the “0” state to the “1” state is irreversible. Therefore, the memory element is a write-once memory.

The CPU 109 can write an encryption/decryption program into such a memory element 783. The written encryption/decryption program can also be read by the CPU 109.

It is to be noted that the present embodiment mode can be implemented by freely combining with the above embodiment modes.

### Embodiment Mode 4

In the present embodiment mode, a cross sectional view of a memory which is different from the EEPROM described in Embodiment Mode 2, will be explained.

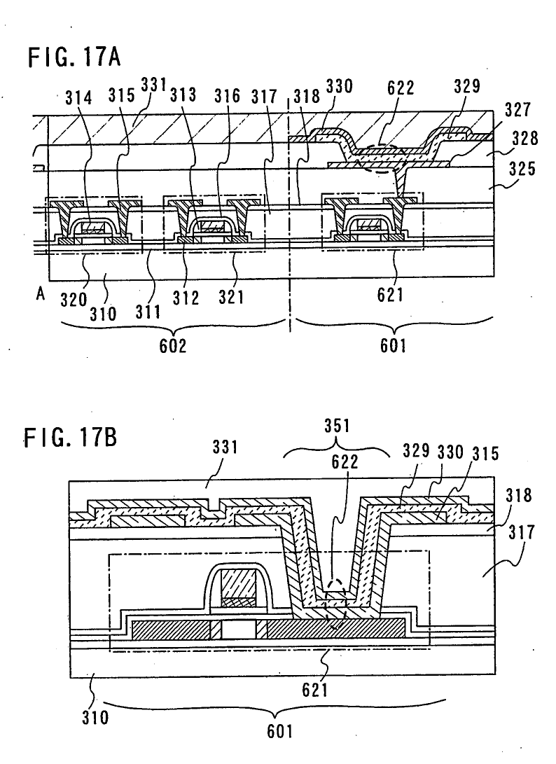

FIG. 17A shows a cross sectional view of a memory element in which a memory cell portion 601 and a driver circuit portion 602 are integrally formed over an insulating substrate 310. For the insulating substrate 310, a glass substrate, a quartz substrate, a substrate made of silicon, a metal substrate, or the like can be used.

A base film 311 is provided over the insulating substrate 310. In the driver circuit portion 602, thin film transistors 320 and 321 are provided over the base film 311. In the memory cell portion 601, a thin film transistor 621 is provided over the base film 311. In each thin film transistor, a semiconductor film 312 that is etched into an island-shape, a gate electrode 314 that is provided over a gate insulating film, and an insulator (in other words, a sidewall) 313 that is provided on the side surface of the gate electrode are provided. The semiconductor film 312 is formed to have a film thickness of 0.2 μm or less, typically, 40 nm to 170 nm, preferably 50 nm to 150 nm. In addition, an insulating film 316 covering the semiconductor film 312 and the sidewall 313, and an electrode 315, which is connected to an impurity region formed in the semiconductor film 312, are provided. Since the electrode 315 is connected to the impurity region, the electrode 315 can be formed as follows: a contact hole is formed in the gate insulating film and the insulating film 316; a conductive film is formed in the contact hole; and the conductive film is etched selectively.

Amorphous silicon and polycrystalline silicon can be used for a semiconductor film. When polycrystalline silicon is used, amorphous silicon is formed first, and then, heat treatment or laser irradiation is performed to the amorphous silicon to form polycrystalline silicon. At this time, a crystallization temperature can be reduced by performing heat treatment with the use of a metal element represented by nickel or laser irradiation. For the laser irradiation, a laser irradiation apparatus of continuous oscillation or a pulsed oscillation can be used. Further, a crystallization method with heat treatment and a crystallization method in which a continuous oscillation laser or a laser beam that oscillates with frequency of 10 MHz or more is emitted, may be combined. By the irradiation of the continuous oscillation laser or the laser beam that oscillates with frequency of 10 MHz or more, a planar surface of the crystallized semiconductor film can be made. Accordingly, the gate insulating film can be thinned and resistance to pressure of the gate insulating film can be improved.

Further, a semiconductor film is obtained by crystallization in which the semiconductor film is irradiated with the continuous oscillation laser or a laser beam that oscillates with frequency of 10 MHz or more, and scanned in one direction. The semiconductor film has characteristics that a crystal is developed in the scanning direction of the beam. The scanning direction is aligned with a channel length direction (a direction in which carriers flow in the case of forming a channel forming region), and transistors are arranged and combined with a gate insulating film described below; whereby a transistor (TFT) that has few characteristic variations and high field-effect mobility can be obtained.

In the thin film transistor forming the memory of the present invention, an insulating film represented by a gate insulating film or the like can be manufactured by oxidizing or nitriding a surface of the object to be processed by using high-density plasma treatment. High-density plasma treatment is such plasma treatment that the plasma density is 1×10¹¹ cm⁻³ or more, preferably 1×10¹¹ cm⁻³ to 9×10¹⁵ cm⁻³, and high frequency such as a microwave (for example, a frequency of 2.45 GHz) is used. When plasma is generated under such a condition, a low electron temperature becomes about 0.2 eV to 2 eV. The high-density plasma having a feature of a low electron temperature has a low kinetic energy of activated species; therefore, a film can be formed without having plasma damage and a defect so much. In a case where a gate insulating film is formed over an object to be processed, a substrate over which a selectively etched semiconductor film is formed is arranged in a film formation chamber capable of such plasma treatment. Then, the distance between an electrode for generating plasma, in other words, an antenna and the object to be processed (here, a surface of the semiconductor film) is set to be 20 mm to 80 mm, preferably 20 mm to 60 mm to perform the film formation treatment. Such high-density plasma treatment enables low temperature process (a substrate temperature of 400° C. or less) to be achieved. Therefore, plastic with low resistance can be formed over the substrate.

As a film-formation atmosphere of such an insulating film, a nitrogen atmosphere or an oxygen atmosphere can be used. The nitrogen atmosphere is typically a mixed atmosphere of nitrogen and a rare gas; or a mixed atmosphere of nitrogen, hydrogen and a rare gas. As the gas including nitrogen and hydrogen, ammonia can be given. As the rare gas, at least one of helium, neon, argon, krypton, and xenon can be used. The oxygen atmosphere is typically a mixed atmosphere of oxygen and a rare gas, a mixed atmosphere of oxygen, hydrogen, and a rare gas; or a mixed atmosphere of dinitrogen monoxide and a rare gas. As the rare gas, at least one of helium, neon, argon, krypton, and xenon can be used. Further, a mixed atmosphere of hydrogen and a rare gas may be used.

Oxidization or nitriding of the surface of the object to be proceeded can be performed by an oxygen radical (it may include an OH radical) or an nitrogen radical (it may include an NH radical) that is generated by this high-density plasma.

An insulating film having a thickness of 1 to 20 nm, typically, 5 to 10 nm can be formed by treatment using such high-density plasma. A reaction in this case is a solid-state reaction; therefore, an interface state density between the insulating film and a semiconductor film can be remarkably reduced. By such high-density plasma treatment, a surface of the object to be proceeded, for example, crystalline silicon or polycrystalline silicon in the case of the semiconductor film is directly oxidized or nitrided. Therefore, variation of a thickness of the insulating film to be formed can be remarkably reduced. In addition, in the case of crystalline silicon, oxidization is not strongly implemented in a crystal grain boundary; therefore, an extremely preferable state is obtained. Accordingly, by performing solid-state oxidization of the surface of the semiconductor film by the high-density plasma treatment, a uniform insulating film of which an interface state density is reduced, can be formed without an unusual oxidization reaction in the crystal grain boundary.

The insulating film thus formed does not damage another coating film so much and can be dense. In addition, the insulating film formed by the high-density plasma treatment can improve the state of an interface that is in contact with the insulating film. For example, when the gate insulating film is formed using the high-density plasma treatment, the state of the interface with the semiconductor film can be improved. As a result, electrical characteristics of a thin film transistor can be improved.

The case of using the high-density plasma treatment for manufacturing the insulating film is explained; however, the high-density plasma treatment may be implemented to the semiconductor film as well. By the high-density plasma treatment, property modification of a surface of the semiconductor film can be performed. As a result, the state of the interface can be improved, and correspondingly, the electrical characteristics of a thin film transistor can be improved.

As an insulating film such as a gate insulating film in the present invention, only an insulating film that is formed by high-density plasma treatment may be used. In addition, an insulating film such as silicon oxide, silicon oxynitride, or silicon nitride may be deposited and stacked over the insulating film by a CVD method utilizing plasma or a heat reaction. In any case, in a transistor in which the insulating film formed by high-density plasma is included partially or entirely in the gate insulating film, variation of characteristics can be reduced.

Encryption algorithm with higher security has a tendency that capacity of an encryption/decryption program is increased. Therefore, in the case of mounting the encryption algorithm on a wireless chip of the present invention, it is required to increase capacity of a memory in the wireless chip. By using the insulating film that is formed by the above high-density plasma treatment for an insulating film of the memory in the wireless chip, variation can be suppressed, and it can be expected that yield of manufacturing the wireless chip is improved even if the capacity of the memory is large.

The case of using high-density plasma treatment for manufacturing an insulating film is explained; however, the high-density plasma treatment may be implemented to the semiconductor film. By the high-density plasma treatment, property modification of a surface of the semiconductor film can be performed. As a result, the state of the interface can be improved, and correspondingly, electrical characteristics of a thin film transistor can be improved.

Further, in order to improve the planarity, insulating films 317 and 318 may be provided. At this time, the insulating film 317 may be formed of an organic material and the insulating film 318 may be formed of an inorganic material. In a case where the insulating films 317 and 318 are provided, the electrode 315 can be formed so as to be connected to the impurity region through a contact hole in these insulating films 317 and 318.

Furthermore, an insulating film 325 is provided and a lower electrode 327 is formed so as to be connected to the electrode 315. An insulating film 328 covering an end portion of the lower electrode 327 is formed, which is provided with an opening so as to expose the lower electrode 327. Inside the opening, a memory material layer 329 is formed and an upper electrode 330 is formed. In this manner, a memory element 622 including the lower electrode 327, the memory material layer 329, and the upper electrode 330 can be formed. The memory material layer 329 can be formed of an organic material or an inorganic material. The lower electrode 327 or the upper electrode 330 can be formed of a conductive material. For example, a film made from an element such as aluminum (Al), titanium (Ti), molybdenum (Mo), tungsten (W), or silicon (Si); or an alloy film using the element can be used. Further, a light-transmitting material such as indium tin oxide (I), indium tin oxide containing silicon oxide, or indium oxide containing zinc oxide of 2% to 20% can also be used.

In order to further improve planarity and prevent an impurity element from entering, an insulating film 331 may be formed.

For the insulating film explained in the present embodiment mode, an inorganic material or an organic material can be used. As the inorganic material, silicon oxide or silicon nitride can be used. As the organic material, polyimide, acryl, polyamide, polyimidamide, resist or benzocyclobutene, siloxane, or polysilazane can be used. It is to be noted that a siloxane resin corresponds to a resin containing an Si—O—Si bond. Siloxane is formed of a skeleton structure of the bond of silicon (Si) and oxygen (O), in which an organic group containing at least hydrogen (such as an alkyl group or aromatic hydrocarbon) is included as a substituent. A fluoro group may be used as the substituent. Alternatively, an organic group containing at least hydrogen and a fluoro group may be used as the substituent. Polysilazane is formed by using a polymer material having the bond of silicon (Si) and nitrogen (Ni) as a starting material.

FIG. 17B shows a cross sectional view of a memory element in which a memory material layer is formed inside a contact hole 351 of an electrode 315, which is different from FIG. 17A. The electrode 315 is used as a lower electrode, and a memory material layer 329 and an upper electrode 330 are formed over the electrode 315 to form a memory element 622 similarly to FIG. 17A Thereafter, an insulating film 331 is formed. The other structure is the same as FIG. 17A; thus description thereof is omitted.

By forming the memory element in the contact hole 351, miniaturization of a memory can be achieved. Further, since an electrode for a memory is not required, the number of manufacturing steps is reduced and a memory formed at low cost can be provided.

In such a manner, a memory that can be applied to a wireless chip of the present invention is manufactured over an insulating substrate, and a driver circuit can be integrally formed. Therefore, manufacturing cost can be reduced.

### Embodiment Mode 5

In the present embodiment mode, a layout of a thin film transistor that is a part of a circuit included in a wireless chip will be explained.

A semiconductor layer that corresponds to the semiconductor film 312 shown in the above embodiment mode is formed on an entire or a part of a surface (a region having a larger area than a region defined as a semiconductor region of a transistor) of a substrate having an insulating surface through a base film or the like. Then, a mask pattern is formed over the semiconductor layer by a photolithography technique. The semiconductor layer is subjected to etching treatment with the use of the mask pattern; whereby a semiconductor pattern with an island-shape, which has a specific shape including a source region, a drain region, and a channel forming region of a thin film transistor, can be formed. A shape of the semiconductor layer that is subjected to the pattern formation is determined in consideration of required characteristics of a circuit and adequacy of a layout, based on characteristics of the thin film transistor.

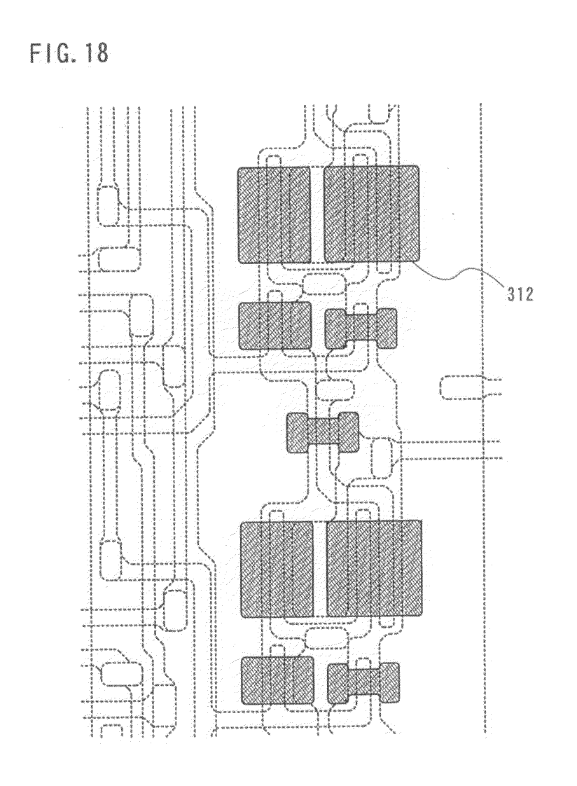

In the thin film transistor of the present invention, a photomask for forming the semiconductor layer is provided with a pattern. The pattern of this photomask has a rounded corner of which an angle is an obtuse angle. A shape of this mask pattern can be transferred as a pattern shape of the semiconductor layer as shown in FIG. 18. When the photomask pattern shape is transferred to the semiconductor layer, it may be transferred so that a corner of the semiconductor film is more rounded than a corner of the photomask pattern. In other words, the corner of the pattern of the semiconductor film may be provided with a rounded pattern shape that is smoother than the corner of the photomask pattern. It is to be noted that a gate electrode and a wiring formed afterward are represented by a dot line in FIG. 18.

Next, a gate insulating film is formed over the semiconductor layer that is etched to have the rounded corner. Then, as shown in the above embodiment mode, a gate electrode 314 is formed so as to be overlapped with a part of the semiconductor layer. A gate wiring is also formed at the same time. The gate electrode or the gate wiring can be formed by a photolithography technique after depositing a metal layer or a semiconductor layer.

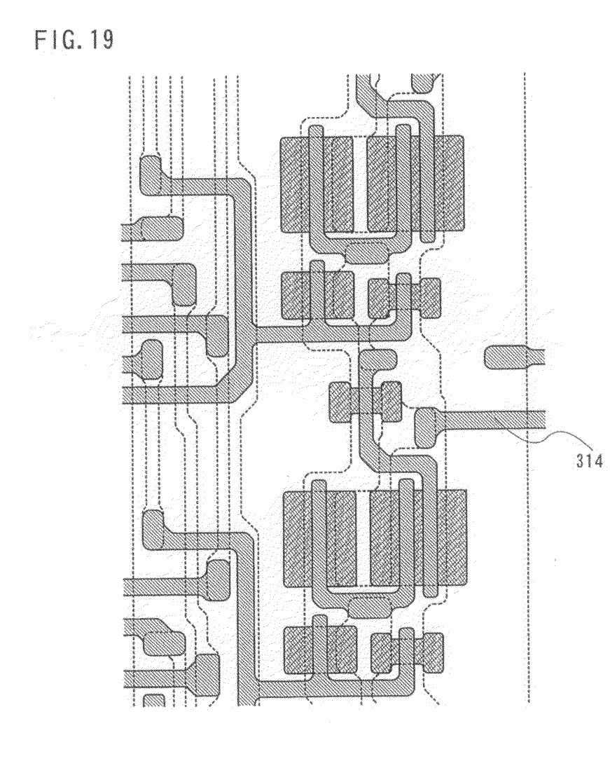

This photomask for forming the gate electrode or the gate wiring is provided with a pattern. The pattern of the photomask has a corner where a pattern with a right-angled triangle shape is removed. The right-angled triangle shape has an oblique line, which is 10 μm or is ½ or less of the line width of a wiring and ⅕ or more of the line width. This mask pattern shape can be transferred as a pattern shape of a gate electrode or a gate wiring as shown in FIG. 19. When the mask pattern shape is transferred to the gate electrode or the gate wiring, it may be transferred so that a corner of the gate electrode or the gate wiring is further rounded. In other words, the corner of the gate electrode or the gate wiring may be provided with a rounded pattern shape that is smoother than a corner of the photomask pattern. In the corner of the gate electrode or the gate wiring that is formed using such a photomask, a rounded corner can be provided by removing a right-angled triangle shape pattern of which an oblique line is ½ or less of the line width of a wiring and ⅕ or more of the line width. It is to be noted that a wiring that is formed afterward is represented as a dot line in FIG. 19.

Such a gate electrode or a gate wiring is bent into a rectangle under constraints of a layout. Therefore, an exterior side and an interior side of the corner of the gate electrode or the gate wiring are to be rounded. In the exterior side of the rounded corner, generation of fine particles due to unusual discharge can be suppressed through dry etching by plasma. Further, in the interior side of the rounded corner, even if fine particles are generated due to unusual discharge at dry etching by plasma, the fine particles can be easily cleaned away in cleaning, so that the fine particles can be prevented from gathering in the corner. As a result, there is an effect that improvement of yield can be remarkably expected.

Next, an insulating layer or the like corresponding to the insulating films 316, 317, and 318 as shown in the above embodiment mode, is formed over the gate electrode or the gate wiring. As a matter of course, an insulating film in the present invention may be a single layer.

Then, an opening is formed in an insulating film in a predetermined portion over the insulating layer. A wiring corresponding to the electrode 315 is formed in the opening. This opening is provided for electrically connecting the semiconductor layer or the gate wiring layer positioned in the lower layer, and the wiring layer. As for the wiring, a mask pattern is formed by a photolithography technique and the wiring is formed into a predetermined pattern by an etching process.

By the wiring, specific elements can be connected. This wiring does not connect the specific elements by a straight line. The wiring is bent into a rectangle (hereinafter, referred to as a bent portion) under constraints of the layout. Further, a wiring width may be changed in an opening portion or another region. For example, in the opening portion, in a case where an opening width is the same as or larger than the wiring width, the wiring width in the portion is changed to be enlarged. Furthermore, the wiring serves as one of electrodes of a capacitor portion in the layout of the circuit; therefore, the wiring width may be set to be large.

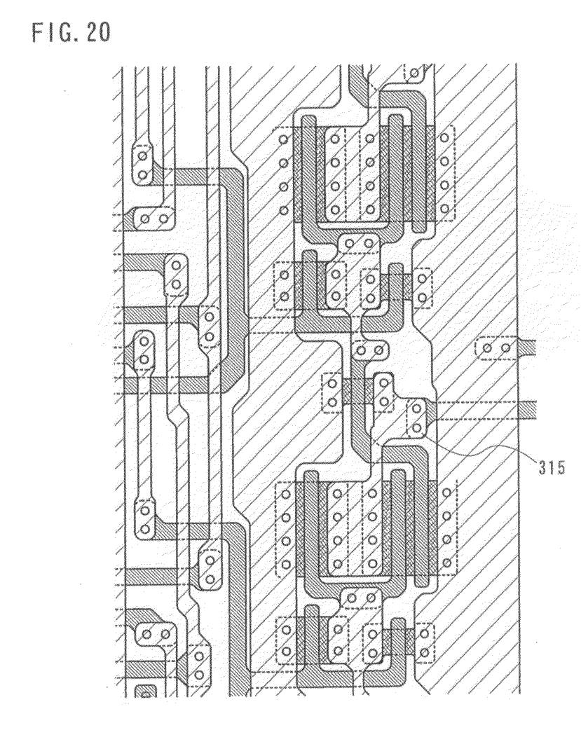

In this case, in the bent portion of the pattern of the photomask, a pattern with a right-angled triangle shape is removed. The right-angled triangle shape has an oblique line, which is 10 μm or less, or is ½ or less of the line width of a wiring and ⅕ or more of the line width. Further, a pattern of the wiring is provided with the similar roundness as shown in FIG. 20. In a corner of the wiring, the bent portion can be rounded by removing the pattern with the right-angled triangle shape of which an oblique line is ½ or less of the line width of a wiring and ⅕ or more of the line width. In an exterior side of the bent portion in such a rounded wiring, generation of fine particles due to unusual discharge is suppressed through dry etching by plasma. In an interior side of the bent portion, even if fine particles are generated due to unusual discharge at dry etching by plasma, the fine particles can be easily cleaned away in cleaning, so that the fine particles can be prevented from gathering in the corner. As a result, there is an effect that improvement of yield can be remarkably expected. By providing the rounded corner of the wiring, electrical conductivity can be expected.

When a corner of the bent portion or a portion in which the wiring width is changed is smoothed and rounded in a circuit having the layout shown in FIG. 20, following effects can be obtained. In dry etching by plasma, generation of fine particles due to unusual discharging can be suppressed. Even if fine particles are generated due to unusual discharge at dry etching by plasma, the fine particles can be easily cleaned away in cleaning, so that the fine particles can be prevented from gathering in the corner. As a result, improvement of yield can be remarkably expected. In other words, a problem of dust and fine particles in manufacturing steps can be solved. Further, when a configuration with a rounded corner of the wiring is provided is employed, electrical conductivity can be expected. In particular, it is extremely convenient to enable dust to be cleaned away in the wiring of a driver circuit portion provided with a number of parallel wirings or the like.

It is to be noted that a mode in which the corner or the bent portion is provided to be rounded in three layouts of the semiconductor layer, the gate wiring, and the wiring is explained in the present embodiment mode; however, the preset invention is not limited thereto. In other words, it is preferable that a problem of dust and fine particles or the like in the manufacturing steps be solved by providing a rounded corner or a rounded bent portion in any one of the layers.

### Embodiment Mode 6

In the present embodiment mode, a photomask or a reticle for forming a transistor of a circuit included in a wireless chip will be explained.

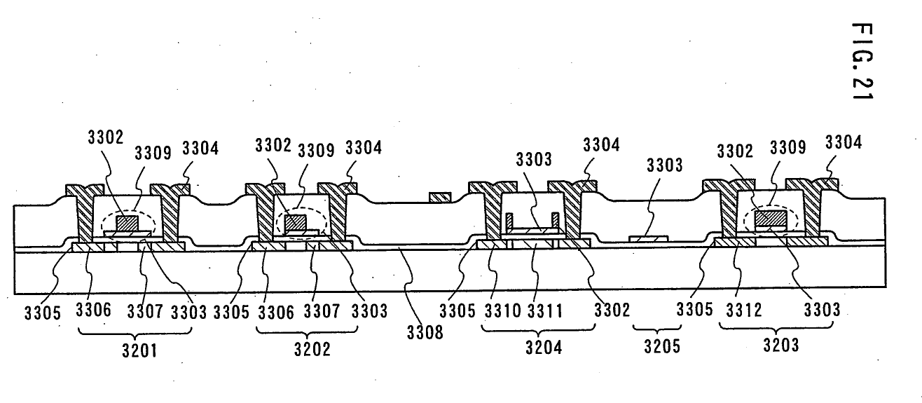

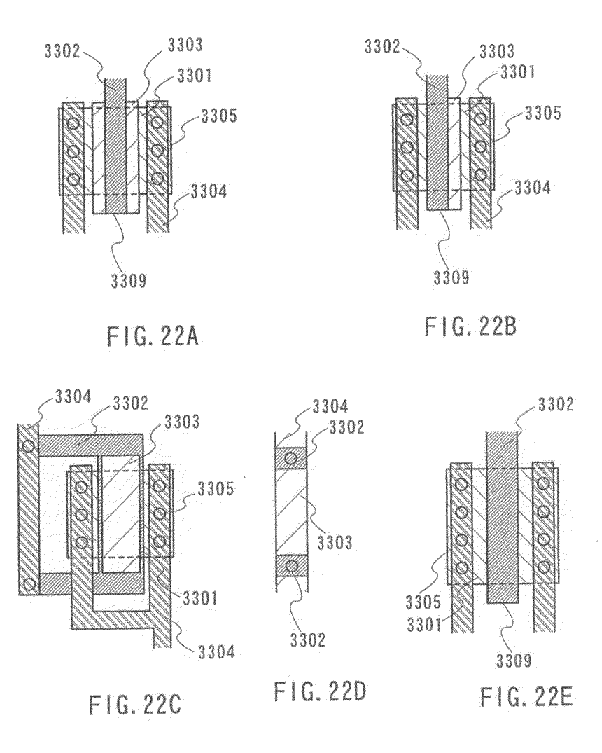

The wireless communication circuit 111, the CPU 109, and the memory 110 described in Embodiment Mode 1, are formed by including transistors. The transistors can be constituted by a thin film transistor as well as by a MOS transistor that is formed over a single crystal substrate. FIG. 21 shows a cross sectional structure of the transistors constituting these circuits. In FIG. 21, an n-channel transistor 3201, an n-channel transistor 3202, a capacitor element 3204, a resistance element 3205, and a p-channel transistor 3203 are shown. Each transistor is provided with a semiconductor layer 3305, an insulating layer 3308, and a gate electrode 3309. The gate electrode 3309 is formed by stacking a first conductive layer 3303 and a second conductive layer 3302. Further, FIGS. 22A to 22E are top views corresponding to the transistor, the capacitor element, and the resistance element shown in FIG. 21, which can be referred with FIG. 21.

In FIG. 21, in the n-channel transistor 3201, low concentration drains (LDD) are formed on both sides of the gate electrode in a channel length direction (a direction in which carriers flow). The low concentration drain (LDD) is an impurity region 3307 that is doped at a lower concentration than an impurity concentration of an impurity region 3306 that forms source and drain regions and are in contact with a wiring 3304. In a case where the n-channel transistor 3201 is formed, phosphorus or the like is added as an impurity that imparts n-type conductivity into the impurity region 3306 and the impurity region 3307. The LDD is formed as a means for suppressing hot electron deterioration and short-channel effect.

As shown in FIG. 22A, the first conductive layer 3303 is formed by being extended on both sides of the second conductive layer 3302 in the gate electrode 3309 of the n-channel transistor 3201. In this case, a film thickness of the first conductive layer 3303 is made to be thinner than a film thickness of the second conductive layer. The first conductive layer 3303 is formed to have a thickness that can pass ion spices accelerated in an electric field of 10 to 100 kV to pass. The impurity region 3307 is formed to be overlapped with the first conductive layer 3303 of the gate electrode 3309. In other words, an LDD region that is overlapped with the gate electrode 3309 is formed. In this structure of the gate electrode 3309, an impurity of one conductivity type is added through the first conductive layer 3303 with the use of the second conductive layer 3302 as a mask so that the impurity region 3307 is formed in a self-aligned manner. In other words, an LDD that is overlapped with the gate electrode is formed in a self-aligned manner.

A transistor having LDDs on both sides is applied to a transistor that forms a TFT for rectifying the electric power generation circuit 102 in FIG. 2, and a transmission gate (also called an analog switch) used in a logic circuit. In these TFTs, both positive and negative voltages are applied to a source electrode or a drain electrode; therefore, LDDs are preferably formed on both sides of a gate electrode.

In FIG. 21, in the n-channel transistor 3202 the impurity region 3307 is formed on one side of the gate electrode in the semiconductor layer 3305, which is doped at a lower impurity concentration than an impurity concentration of the impurity region 3306. As shown in FIG. 22B, in the gate electrode 3309 of the n-channel transistor 3202, the first conductive layer 3303 is formed by being extended on one side of the second conductive layer 3302. In this case, an impurity of one conductivity type is added through the first conductive layer 3303 with the use of the second conductive layer 3302 as a mask so that an LDD can be formed in self-aligned manner in the similar way.

A transistor having an LDD on one side may be applied to a transistor in which only a positive voltage or only a negative voltage is applied between source and drain electrodes. Specifically, the transistor having an LDD on one side may be applied to a transistor that forms a logical gate such as an inverter circuit, a NAND circuit, a NOR circuit, or a latch circuit; or a transistor that forms an analog circuit such as a sense amplifier, a constant voltage generation circuit, or a VCO.

In FIG. 21, in the capacitor element 3204, the insulating layer 3308 is interposed between the first conductive layer 3303 and the semiconductor layer 3305. The semiconductor layer 3305, which forms the capacitor element 3204, is provided with an impurity region 3310 and an impurity region 3311. The impurity region 3311 is formed to be overlapped with the first conductive layer 3303 in the semiconductor layer 3305. The impurity region 3310 is in contact with the wiring 3304. An impurity of one conductivity type can be added into the impurity region 3311 through the first conductive layer 3303 so that the impurity region 3310 and the impurity region 3311 can have the same impurity concentration or different impurity concentrations. In any case, the semiconductor layer 3305 serves as an electrode in the capacitor element 3204; therefore, the semiconductor layer 3305 is preferably made to have lower resistance by adding an impurity of one conductivity type. As shown in FIG. 22C, by using the second conductive layer 3302 as a supporting electrode, the first conductive layer 3303 can sufficiently serve as an electrode. In such a manner, by employing a multiple electrode structure in which the first conductive layer 3303 and the second conductive layer 3302 are combined, the capacitor element 3204 can be formed in a self-aligned manner.

The capacitor element is used as a storage capacitor included in the electric power generation circuit 102 or a resonance capacitor included in the resonance circuit 101 in FIG. 2. In particular, the resonance capacitor is required to serve as a capacitor without depending on positive or negative of a voltage between two terminals because both positive and negative voltages are applied between two terminals of the capacitor element.

In FIG. 21, the resistance element 3205 is formed of the first conductive layer 3303. The first conductive layer 3303 is formed to have a thickness of approximately 30 to 150 nm; therefore, a resistance element can be formed by appropriately setting a width and a length thereof.

The resistance element is used as a resistance load included in the modulation circuit 105 in FIG. 2. Further, the resistance element may be used as a load in the case of controlling a current by a VCO. The resistance element may be formed by a semiconductor layer including an impurity element at a high concentration and a metal layer with a thin film thickness. A resistance value of the semiconductor layer depends on a film thickness, a film quality, an impurity concentration, an activation ratio, and the like. On the other hand, a resistance value of the metal layer is determined by a film thickness and a film quality; therefore, variation is small, which is preferable.

In FIG. 21, the p-channel transistor 3203 is provided with an impurity region 3312 in the semiconductor layer 3305. In this impurity region 3312, source and drain regions are formed, which are in contact with the wirings 3304. A structure of the gate electrode 3309 is a structure in which the first conductive layer 3303 and the second conductive layer 3302 are overlapped with each other. The p-channel transistor 3203 is a transistor having a single drain structure where an LDD is not provided. When the p-channel transistor 3203 is formed, boron or the like is added as an impurity that imparts p-type conductivity into the impurity region 3312. On the other hand, when phosphorus is added into the impurity region 3312, an n-channel transistor having a single drain structure can be formed.

One or both of the semiconductor layer 3305 and the insulating layer 3308 may be subjected to oxidation treatment or nitriding treatment by high-density plasma treatment using a microwave, in which an electron temperature is 2 eV or less, ion energy is 5 eV or less, and an electron density is approximately 10¹¹ to 10¹³/cm³. Details can be referred to the above embodiment mode.

As explained above with reference to FIG. 21 and FIGS. 22A to 22E, by combining conductive layers with different film thicknesses, elements having various structures can be formed. A region where only a first conductive layer is formed and a region where a first conductive layer and a second conductive layer are stacked can be formed by using a photomask or a reticle provided with an assist pattern including a diffraction grating pattern or a function of reducing light intensity, which is made of a semi-transparent film. In other words, in the case of exposing photoresists in a photolithography step, transmission light quantity of the photomask is adjusted so as to make thicknesses of the developed resist masks different. In this case, a slit that is equal to or less than resolution limitation is provided in the photomask or the reticle; then, a resist having the above-complicated shape may be formed. Further, baking at approximately 200° C. is performed after development, and a mask pattern that is formed of a photoresist material may be transformed.

In addition, by using a photomask or a reticle provided with an assist pattern including a diffraction grating pattern or a function of reducing light intensity, which is made of a semi-transparent film, a region where only a first conductive layer is formed and a region where a first conductive layer and a second conductive layer are stacked, can be formed continuously. As shown in FIG. 22A, a region where only a first conductive layer is formed can be selectively formed over the semiconductor layer. Such a region is effective when it is formed over the semiconductor layer. However, the region is not necessary in other regions (wiring regions connected to the gate electrode). In the wiring portions, a region where only a first conductive layer is formed is not required to be formed by using this photomask or reticle; therefore, the wiring density can be substantially increased.

In the case of FIG. 21 and FIGS. 22A to 22E, the first conductive layer is formed of a refractory metal such as tungsten (W), chromium (Cr), tantalum (Ta), tantalum nitride (TaN), or molybdenum (Mo); or an alloy or a compound that mainly contains the refractory metals, with a thickness of 30 to 50 nm. Further, the second conductive layer is formed of a refractory metal such as tungsten (W), chromium (Cr), tantalum (Ta), tantalum nitride (TaN), or molybdenum (Mo); or an alloy or a compound that mainly contains the refractory metals, with a thickness of 300 to 600 nm. For example, different conductive materials are respectively used for the first conductive layer and the second conductive layer to generate a difference of an etching rate in an etching step that is subsequently performed. As an example, TaN as the first conductive layer and a tungsten film as the second conductive layer can be used.

The present embodiment mode shows a transistor, a capacitor element, and a resistance element having different electrode structures, which can be formed in the same manufacturing steps, by using a photomask or reticle provided with a diffraction grating pattern or an assist pattern including a function of reducing light intensity, which is made of a semi-transparent film. Therefore, elements having different modes can be formed without increasing steps and integrated depending on characteristics of circuits.

This application is based on Japanese Patent Application serial no. 2005-158224 filed in Japan Patent Office on May 3 in 2005, the entire contents of which are hereby incorporated by reference.

### Explanation of Reference

100: wireless chip, 101: resonance circuit, 102: electric power generation circuit, 103: clock generation circuit, 104: demodulation circuit, 105: modulation circuit, 106: data extraction circuit, 107: coding circuit, 108: control resistor, 109: CPU, 110: memory, 111: wireless communication circuit, 200: reader/writer, 300: instruction, 301: address, 302: data, 310: insulating substrate, 311: base film, 312: semiconductor film, 313: sidewall, 314: gate electrode, 315: electrode, 316: insulating film, 317: insulating film, 318: insulating film, 320: thin film transistor, 325: insulating film, 327: lower electrode, 328: insulating film, 329: memory material layer, 330: upper electrode, 331: insulating film, 351: contact hole 400: ROM region, 401: RAM region, 402: EEPROM region, 500: insulating substrate, 501: drain region (high concentration n-type impurity region), 502: drain region, 504: channel forming region, 505: channel forming region, 506: gate insulating film, 507: gate insulating film, 508: floating gate electrode, 509: gate electrode, 510: gate insulating film, 511: control gate electrode, 512: interlayer film, 513: source wiring, 514: drain wiring, 601: memory cell portion, 602: driving circuit portion, 621: thin film transistor, 622: memory element, 707: memory, 751: column decoder, 752: row decoder, 753: selector, 754: circuit, 755: circuit, 756: memory cell array, 757: memory cell, 781: transistor, 783: memory element, 784: diode, 790: resistance element, 791: sense amplifier, 801: X address decoder, 802: Y address decoder, 803: peripheral circuit, 805: memory cell array, 3201: n-channel transistor, 3202: n-channel transistor, 3203: p-channel transistor, 3204: capacitor element, 3205: resistance element, 3302: conductive layer, 3303: conductive layer, 3304: wiring, 3305: semiconductor layer, 3306: impurity region, 3307: impurity region, 3308: insulating layer, 3309: gate electrode, 3310: impurity region, 3311: impurity region, 3312: impurity region, 4020: flag, 4021: encryption program top address, 4022: decryption program top address, 4023: region, 4024: region, 4025: region, 4026: region.

1. A semiconductor device comprising:
a circuit capable of communicating information by wireless communication;
a CPU; and
a memory,
wherein the memory comprises a plurality of regions to which at least one of an encryption program and a decryption program is assigned.

2. A semiconductor device comprising:
a control resistor;
a CPU; and
a memory,
wherein the memory comprises a plurality of regions in which at least one of an encryption program and a decryption program is recorded, and
wherein the CPU activates the decryption program that is recorded in the memory in a case of writing encryption information into the control resistor, and decrypts the encryption information that is written into the control resistor.

3. A semiconductor device comprising:
a resonance circuit having an antenna and a resonance capacitor;
a control resistor;
a CPU; and
a memory,
wherein the memory comprises a plurality of regions in which at least one of an encryption program and a decryption program is recorded,
wherein the resonance circuit has a function for receiving an electric wave and generating an alternating current signal on both sides of the antenna, and
wherein the CPU activates the decryption program that is recorded in the memory in a case of writing encryption information into the control resistor, and decrypts the encryption information that is written into the control resistor.

4. A semiconductor device comprising:
a resonance circuit having an antenna and a resonance capacitor;
an electric power generation circuit;
a control resistor;
a CPU; and
a memory,
wherein the memory has a plurality of regions in which at least one of an encryption program and a decryption program is recorded,
wherein the resonance circuit has a function for receiving an electric wave and generating an alternating current signal on both sides of the antenna,
wherein the electric power generation circuit has a function for rectifying the alternating current signal by a diode and smoothing the alternating current signal with the use of a capacitor to generate an electric power, and
wherein the CPU activates the decryption program that is recorded in the memory in a case of writing encryption information in to the control resistor, and decrypts the encryption information that is written into the control resistor.

5. A semiconductor device comprising:
a resonance circuit having an antenna and a resonance capacitor;
an electric power generation circuit;
a clock generation circuit;
a control resistor;
a CPU; and
a memory,
wherein the memory has a plurality of regions in which at least one of an encryption program and a decryption program is recorded,
wherein the resonance circuit has a function for receiving an electric wave and generating an alternating current signal on both sides of the antenna,
wherein the electric generation circuit has a function for rectifying the alternating current circuit by a diode and smoothing the alternating current circuit with the use of the capacitor to generate an electric power,
wherein the clock generation circuit has a function for generating a clock signal based on the alternating current signal, and
wherein the CPU activates the decryption program that is recorded in the memory in a case of writing encryption information into the control resistor and decrypts the encryption information that is written into the control resistor.

6. A semiconductor device comprising:
a resonance circuit having an antenna and a resonance capacitor;
an electric power generation circuit;
a clock generation circuit;
a demodulation circuit;
a data extraction circuit;
a control resistor;
a CPU; and
a memory,
wherein the memory has a plurality of regions in which at least one of an encryption program and a decryption program is recorded,
wherein the resonance circuit has a function for receiving an electric wave and generating an alternating current signal on both sides of the antenna;
wherein the electric power generation circuit has a function for rectifying the alternating current signal by a diode and smoothing the alternating current signal with the use of a capacitor to generate an electric power,
wherein the clock generation circuit has a function for generating a clock signal based on the alternating current signal,
wherein the demodulation circuit has a function for demodulating the alternating current signal and transmitting demodulated data to the data extraction circuit, and
wherein the CPU activates the decryption circuit that is recorded in the memory in a case of writing encryption information into the control resistor, and decrypts the encryption information that is written into the control resistor.

7. A semiconductor device comprising:
a resonance circuit having an antenna and a resonance capacitor;
an electric generation circuit;
a clock generation circuit;
a demodulation circuit;
a modulation circuit;
a data extraction circuit;
a control resistor;
a CPU; and
a memory,
wherein the memory has a plurality of regions in which at least one of an encryption program and a decryption program is recorded,
wherein the resonance circuit has a function for receiving an electric wave and generating an alternating current signal on both sides of the antenna,
wherein the electric power generation circuit has a function for rectifying the alternating current signal by a diode and smoothing the alternating current signal with the use of a capacitor to generate an electric power,
wherein the clock generation circuit has a function for generating a clock signal based on the alternating current signal,
wherein the demodulation circuit has a function for demodulating the alternating current signal and transmitting demodulated data to the data extraction circuit,
wherein the data extraction circuit has a function for extracting encryption information from the demodulated data and writing the extracted encryption information into the control resistor,
wherein the modulation circuit has a function for modulating a coded signal in which information of the control resistor is coded and outputting modulated data to the resonance circuit, and
wherein the CPU activates the decryption program that is recorded in the memory in case of writing encryption information into the control resistor, and decrypts the encryption information that is written into the control resistor.

8. A semiconductor device according to any one of claims 1 to 7, wherein the memory includes a memory that has a structure capable of being rewritten.

9. A semiconductor device according to any one of claims 1 to 7, wherein the memory includes a write-once memory.

10. A method for operating a semiconductor device, which includes a circuit capable of communicating information by wireless communication, a CPU, and a memory, comprising the steps of:
writing a first encryption program into a first region of the memory;
writing a second encryption program into a second region of the memory; and
writing a third encryption program into a third region of the memory.

11. A method for operating a semiconductor device, which includes a circuit capable of communicating information by a wireless communication, a CPU, and a memory, comprising the steps of:
writing a first decryption program into a first region of the memory;
writing a second decryption program into a second region of the memory; and
writing a third decryption program into a third region of the memory.

12. A method for operating a semiconductor device, which includes a circuit capable of communicating information by wireless communication, a CPU, and a memory, comprising the steps of:
writing a first encryption program into a first region of the memory;
writing a second encryption program into a second region of the memory; and
writing a third encryption program into the first region of the memory.

13. A method for operating a semiconductor device, which includes a circuit capable of communicating information by wireless communication, a CPU, and a memory, comprising the steps of:
writing a first decryption program into a first region of the memory;
writing a second decryption program into a second region of the memory; and
writing a third decryption region into the first region of the memory.

14. A method for operating a semiconductor device according to any one of claims 10 to 13, wherein the memory includes a memory that has a structure capable of being rewritten.

15. A method for operating a semiconductor device according to any one of claims 10 to 11, wherein the memory includes a write-once memory.
